(19) United States
(12) Patent Application Publication
(10) Pub. No.: US 2025/0277479 A1
(43) Pub. Date: Sep. 4, 2025

(54) RESTART CONTROL METHOD AND DEVICE FOR INTERNAL COMBUSTION ENGINE

(71) Applicant: NISSAN MOTOR CO., LTD., Yokohama-shi (JP)

(72) Inventor: Shouta HAMANE, Kanagawa (JP)

(73) Assignee: NISSAN MOTOR CO., LTD., Yokohama-shi (JP)

(21) Appl. No.: 19/061,039

(22) Filed: Feb. 24, 2025

(30) Foreign Application Priority Data
Feb. 29, 2024 (JP) 2024-029328

(51) Int. Cl. F02N 11/08

(52) U.S. Cl. CPC F02N 11/08

(57) ABSTRACT

A rotation speed and crank angle of the internal combustion engine are obtained each time when a crank angle sensor signal is input, which is output by a crank angle sensor at each predetermined crank angle, for each forward and reverse rotation direction, after the automatic stop. A prediction time expected for the rotation speed of the internal combustion engine to reach a starter allowable rotation speed range where the starter motor can be driven is calculated, based on the rotation speed and crank angle, and it is set to a timer. A timer value is updated each time when the crank angle sensor signal is input, and is subtracted with the lapse of time. It is determined whether or not the restart request has already been made when the timer value reaches 0, and when it has already been made, the drive of the motor starter is started.

### BACKGROUND

The present invention relates to a restart control method and device in which, after automatic stop of an internal combustion engine according to a predetermined idling stop condition, restart is performed using a starter motor when restart is requested before the rotation of a crankshaft completely stops.

In a vehicle equipped with an idling stop function, when a predetermined idling stop condition is established, for example, at a temporary stop at an intersection, the automatic stop of an internal combustion engine is performed, following which when a request to start the internal combustion engine due to the establishment of a release condition, such as releasing of a brake pedal, is made, the restart of the internal combustion engine is performed using a starter motor.

Here, there is case where a restart request occurs before the rotation of the crankshaft completely stops, such as when the brake pedal is released immediately after the idling stop condition is established. Although, in general, the rotation speed of the internal combustion engine needs to be sufficiently low for the restart using the starter motor, a crank angle sensor used for detecting the rotation speed of the internal combustion engine outputs a pulse signal, namely, crank angle sensor signal, at each relatively large predetermined crank angle, and in a state in which the rotation speed of the internal combustion engine is low, there is a problem that the output interval (time interval) of the crank angle sensor signal becomes long.

In order to solve such a problem, in Japanese Patent Application Publication No. 2014-190159 (hereinafter is simply referred to as “patent document 1”), when the output interval of the crank angle sensor signal becomes long, the engine speed and crank angle phase are complementary calculated every 10 ms using past signals to determine the engine speed after a predetermined time during inertial rotation. In this case, the timing when the actual engine speed becomes 0 is predicted based on the predicted rotation speed change, and a pinion of the starter motor is engaged with a ring gear at this timing.

However, in the process from the inertial rotation of the crankshaft when the internal combustion engine automatically stops to a complete stop, the compression pressure in a cylinder and valve spring reaction force can cause the crankshaft to rotate in the reverse direction. In the patent document 1, this reverse direction rotation is referred to as “swing back”, and the restart is prohibited during this swing back period. However, in the method of complementary calculation between the engine speed and crank angle phase every 10 ms using past signals as shown the patent document 1, the appropriate timing cannot be determined until a certain period of time has elapsed after the “swing back” is finished, and it may cause a large delay from a restart request to an actual restart.

### SUMMARY

The present invention is a restart control method for an internal combustion engine for performing restarting of the internal combustion engine by using a starter motor when a restart request is made before rotation of a crankshaft completely stops after automatic stop of the internal combustion engine according to a predetermined idling stop condition, the method comprising: obtaining a rotation speed and a crank angle of the internal combustion engine each time when a crank angle sensor signal is input which is output by a crank angle sensor at each predetermined crank angle, for each forward and reverse rotation direction, after the automatic stop; calculating a prediction time expected for the rotation speed of the internal combustion engine to reach a starter allowable rotation speed range where the starter motor can be driven, based on the rotation speed and crank angle; updating the prediction time each time when the crank angle sensor signal is input; determining whether or not the restart request has already been made, when the prediction time has elapsed; and starting the drive of the starter motor when the restart request has already been made.

According to the present invention, since for both forward and reverse directions, the prediction time is updated each time when the crank angle sensor signal is input and when this prediction time elapses, the starter motor starts driving when a restart request has already been made, by relatively simple control, the restart by the starter motor can be performed at a timing when the actual rotation speed in both forward and reverse directions is considered to be within the starter allowable rotation speed range. Therefore, the restart can be performed without significant delay from the restart request.

### BRIEF DESCRIPTION OF THE DRAWINGS

FIG. 1 is a functional block diagram of a restart control device for an internal combustion engine in one embodiment.

FIG. 2 is a flowchart showing a flow of process of restart control for an internal combustion engine in one embodiment.

FIG. 3 is a time chart showing an example of operation in one embodiment.

### DETAILED DESCRIPTION

In the following, one embodiment of the present invention will be explained in detail based on the drawings.

A vehicle on which an internal combustion engine of one embodiment is mounted is equipped with a so-called idling stop function, and when a predetermined idling stop condition, such as releasing of an accelerator pedal and depressing of a brake pedal, is established at a temporary stop at an intersection, the automatic stopping of the internal combustion engine is performed. That is, fuel injection and ignition are stopped in accordance with the command to stop the internal combustion engine, and the rotation of a crankshaft completely stops after a short period of inertial rotation. Then, in the idling stop state, when a predetermined release condition, such as releasing of the brake pedal, is established, a restart request is output, and the restart of the internal combustion engine is performed as mentioned below. In addition, in one embodiment, the internal combustion engine is connected to a stepped-speed automatic transmission via a torque converter, and the automatic stopping and restarting when the vehicle stops can be performed while holding the automatic transmission in a so-called D range.

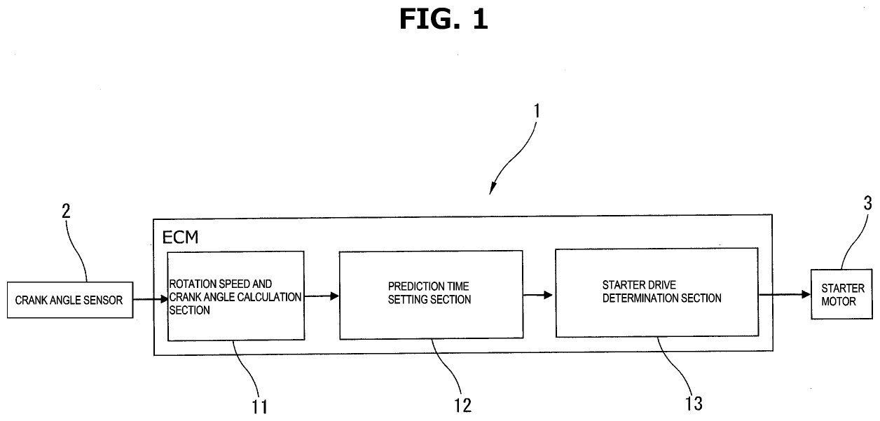

FIG. 1 is a functional block diagram of a restart control device 1 in one embodiment. Restart control device 1 is configured as part of a function of an engine controller for performing various controls of the internal combustion engine. A crank angle sensor signal output by a crank angle sensor 2 at each predetermined crank angle is input to restart control device 1. Crank angle sensor 2 is a general crank angle sensor equipped, for example, with a disk-shaped signal plate provided at the end of the crankshaft and a pickup that detects the passage of protrusions formed on the outer peripheral edge of the signal plate at equal angular intervals. Crank angle sensor 2 is configured to output a pulse signal, namely, crank angle sensor signal formed in a rectangular wave at intervals of approximately 6 to 10° C. A.

A starter motor 3 is connected to restart control device 1 for performing cranking of the internal combustion engine at the time of restart. Starter motor 3 in one embodiment is a general type starter motor in which a pinion moves axially to engage with a ring gear of the internal combustion engine at the start of drive. A starter allowable rotation speed range is predetermined to suppress impact noise when the pinion engages with the ring gear, and when the restart is performed by starter motor 3 in a state in which the rotation of the crankshaft does not completely stop, the rotation speed of the internal combustion engine when the pining begins to engage with the ring gear needs to be within the allowable starter rotation speed range. In one embodiment, the starter allowable rotation speed range is a range set with a predetermined threshold value in the forward rotation direction (for example, +100 to +200 rpm) as the upper limit and 0 as the lower limit.

As illustrated, restart control device 1 is composed of a rotation speed and crank angle calculation section 11, a prediction time setting section 12 and a starter drive determination section 13. Rotation speed and crank angle calculation section 11 calculates the speed (rotation speed) and crank angle of the internal combustion engine based on a crank angle sensor signal, each time when the crank angle sensor signal is input, for both the forward and reverse rotation directions, after the automatic stop by idling stop.

Based on these rotation speed and crank angle, prediction time setting section 12 calculates a prediction time expected until the rotation speed of the internal combustion engine reaches the above starter allowable rotation speed range where starter motor 3 can be driven, and updates this prediction time each time when the crank angle sensor signal is input. In one embodiment, prediction time setting section 12 includes a pre-created map to which a corresponding prediction time using the rotation speed and crank angle as parameters is assigned, and calculates a prediction time by referencing to the map. The prediction time obtained in this way is set in an appropriate clock unit, such as a subtraction timer or addition timer. Then, a newly calculated prediction time is set in the clock unit each time when the crank angle sensor signal is input. That is, the value of the prediction time set in the clock unit is updated each time when the crank angle sensor signal is input.

Starter drive determination section 13 determines whether a restart request has already been made when the prediction time has elapsed, and when the restart request has already been made, it starts the driving of starter motor 3.

The above prediction time is strictly the time required to reach the timing of the command to start driving starter motor 3 in consideration of the starter operation delay time from the command to start driving starter motor 3 until the pinion enters the ring gear. That is, for example, if the prediction time is set as Dt1 and the starter operation delay time is set as Dt2, the command to start driving starter motor 3 is given when the prediction time Dt1 has elapsed, and the prediction time Dt1 is defined such that the rotation speed of the internal combustion engine reaches the allowable starter rotation speed range at the timing when the pinion enters the ring gear after the starter operation delay time Dt2.

In addition, an appropriate prediction time value corresponding to the rotation speed (positive value for forward rotation, negative value for reverse rotation) and crank angle for each of forward and reverse rotations is assigned to the above map. As mentioned above, in the process from the inertial rotation of the crankshaft when the internal combustion engine automatically stops to a complete stop, the compression pressure in a cylinder and valve spring reaction force can cause the rotation direction of the crankshaft to reverse. In such a reversal, the prediction time (delay time set in consideration of starter operation delay time) expected until the rotation speed reaches 0 rpm which is the lower limit of the starter allowable rotation speed range is set based on the map.

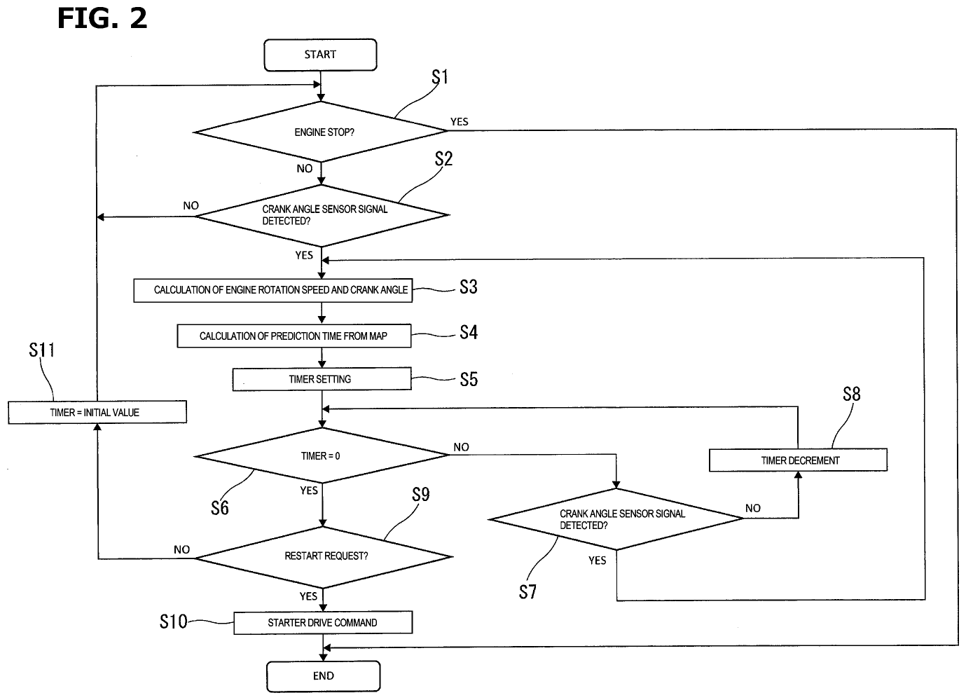

FIG. 2 is a flowchart showing a flow of process of the restart control in one embodiment. This process is repeated each predetermined time after the start of idling stop. In a first step S1, the stop of the internal combustion engine is determined. That is, it is determined whether or not the rotation of the crankshaft has completely stopped, and when the determination is YES, the routine is ended. In addition, the restart after the complete stop is performed according to a different routine not shown.

When the crankshaft inertially rotates, the step proceeds to a step S2, and waiting is performed until a crank angle sensor signal is input. When the input of the crank angle sensor signal is detected, the step proceeds from step S2 to a step S3, and the rotation speed and crank angle of the internal combustion engine are calculated. Then, in a next step S4, by referring to the above-mentioned map, a prediction time is calculated, and, in a step S5, a value of the prediction time is set in a timer consisting of a subtraction counter.

In a next step S6, it is determined whether or not the timer has reached 0. Since the determination in the first time is NO, the step proceeds from step S6 to a step S7, and it is determined whether or not a next crank angle sensor signal input is detected. When the crank angle sensor signal input is not detected, in a step S8, the timer is decremented, and the step is returned to step S6. That is, while the timer does not reach 0, the value of the timer is gradually decreased by repeating the process from step S6 to step S8 until the next crank angle sensor signal input. When the input of the crank angle sensor signal is detected in step S7 before the value of the timer reaches 0 (for example, before the prediction time has elapsed), the step is returned from step S7 to step S3, and the calculation of the rotation speed and crank angle (step S3), the calculation of the prediction time (step S4) and the setting of the prediction time into the timer (step S5) mentioned above are performed again. That is, the prediction time is updated each time when the crank angle sensor signal is input, and the value of the timer is set to a new prediction time.

When it is determined that the timer has reached 0 in step S6 during such repeated updating of the prediction time, the step proceeds from step S6 to a step S9, and it is determined whether or not there is a restart request. When the restart has already requested, the step proceeds from step S9 to a step S10, and the driving signal of starter motor 3 is output. By this driving start, the pinion engages with the ring gear at the timing when the rotation speed of the internal combustion engine enters the starter allowable rotation speed range, and cranking starts.

On the other hand, when the determination in step 9 is NO, that is, when there is still no restart request when the timer has reached 0, the step proceeds to a step S11, and after the value of the timer is returned to the initial value, the step is returned to step S1. Then, when there is the input of a next crank angle sensor signal, the step proceeds to step S3 or later, and the above-mentioned process is repeated.

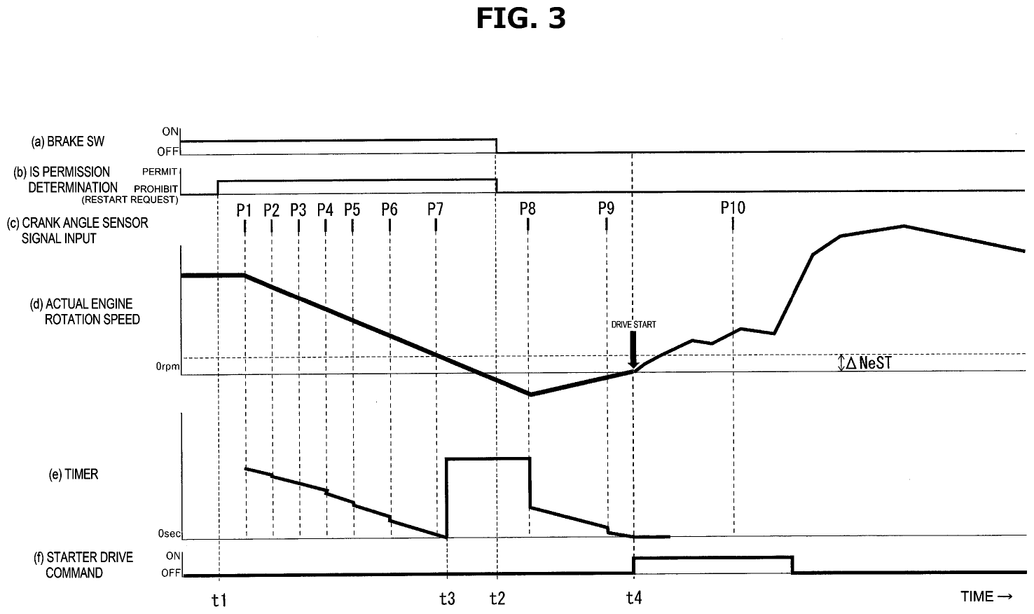

FIG. 3 is a time chart showing an example of an operation by the above-mentioned restart control. From the top of the figure, (a) ON/OFF of brake switch, (b) idling stop permission determination flag, (c) crank angle sensor signal input, (d) actual rotation speed of internal combustion engine, (e) timer value and (f) drive command of starter motor are shown. The crank angle sensor signals shown in column (c) are numbered P1-P10 for convenience. In addition, an example of the allowable starter speed range ΔNeST is shown in column (d), and this range ΔNeST is set with a predetermined threshold value (for example, about +100 to +200 rpm) in the forward rotation direction as the upper limit and 0 as the lower limit.

In an example of this time chart, when the accelerator pedal is released and the brake pedal is depressed for a temporary stop at an intersection, and the vehicle speed becomes 0, at time t1, the idling stop permission determination flag is turned ON and the internal combustion engine is automatically stopped. In addition, when the brake pedal is released at time t2, and the idling stop permission determination flag is set to OFF, which is a restart request.

After the idling stop permission determination flag is turned ON and the fuel injection and ignition of the internal combustion engine stop, the crankshaft of the internal combustion engine rotates inertially for a relatively short period of time, and the actual rotation speed gradually decreases as shown in column (d). Then, in this example, after the actual rotation speed becomes 0, the actual rotation speed becomes further negative value. That is, due to the compression pressure in a cylinder and valve spring reaction force, the crankshaft reverses, and after a slight reversal, the actual rotation speed becomes 0 again. The crank angle sensor signal shown in column (c) is output at each predetermined crank angle of approximately 6-10° C. A, and the lower the rotation speed of the internal combustion engine, the wider the time interval.

In the example of the illustrated time chart, when first crank angle sensor signal P1 after the start of the idling stop is input, the rotation speed and crank angle of the internal combustion engine are calculated, and based on these, a prediction time is obtained. Then, the value of the prediction time is set in a timer shown in column (e). After that, the value of the timer gradually decreases with the lapse of time, but since next crank angle sensor signal P2 is input before the timer value reaches 0, the calculation of the rotation speed and crank angle and the calculation of the prediction time are performed again, and the timer value is updated according to the prediction time at that time. After that, the prediction time is updated each time when a crank angle sensor signal is input as P2, P3, P4 . . . , and the timer is newly set.

In the illustrated example, the value of the timer set based on a crank angle sensor signal P7 reaches 0 at time t3. However, since there is still no restart request at that time, restart is not performed, and the value of the timer is returned to an initial value. This initialized timer value is not subtracted until the input of the next crank angle sensor signal. In addition, although a restart request is made at time t2, at this time, the crankshaft is in reverse state.

When a nest crank angle sensor signal P8 is input, a prediction time is calculated based on crank angle sensor signal P8, and the timer value is updated. The prediction time at this time is one corresponding to the reverse rotation, and is a time required for the rotation speed to reach 0 rpm that is the lower limit of starter allowable rotation speed range ΔNeST.

In the illustrated example, the timer value set at the time of the input of a crank angle sensor signal P9 becomes 0 at time t4. At this time, since a restart request has already been made, the driving of starter motor 3 starts at time t4. Therefore, after the above-mentioned starter operation delay time, the pinion engages with the ring gear and substantial cranking starts. In the timing when the pinion engages with the ring gear in this way, the actual rotation speed of the internal combustion engine is within the starter allowable rotation speed range ΔNeST. In the illustrated example, when the reverse rotation of the crankshaft converges and the actual rotation speed reaches 0 rpm, the pinion engages with the ring gear.

In addition, in the illustrated example, since the timing of the restart request (time t2) is later than the timing when the timer value first reaches 0 (time t3), the restart does not start at time t3. However, if there is a restart request before time t3, the driving of starter motor 3 starts at time t3.

In this way, in the above embodiment, when the restart request is made during the crankshaft inertially rotates, restart by starter motor 3 can be started before the crankshaft is determined to be in a complete stop state, and, for example, the delay from timing t2 when the brake pedal is released to the completion of restart and start is shortened. In particular, even when the restart request is made during the reverse rotation of the crankshaft, similar to the case of the forward rotation, the restart can be started at an earlier appropriate timing.

As the above, although a specific embodiment of the present invention has been explained, the present invention is not limited to the embodiment mentioned above, and various changes might be made to the embodiment without departing from the scope and spirit of the present invention. The present invention includes equivalents thereof.

For example, although the elapse of the prediction time is determined by the subtraction timer in the above embodiment, the elapse of the prediction time may be determined in the form of an additive timer. In addition, specific types of the starter motor and crank angle sensor are not limited to the above embodiment, and other appropriate types can be used. In addition, the starter allowable rotation speed range can be set so as to include a negative rotation speed range.

The entire contents of Japanese Patent Application 2024-29328 filed Feb. 29, 2024 is incorporated herein by reference.

1. A restart control method for an internal combustion engine for performing restarting of the internal combustion engine by using a starter motor when a restart request is made before rotation of a crankshaft completely stops after automatic stop of the internal combustion engine according to a predetermined idling stop condition, the method comprising:
obtaining a rotation speed and a crank angle of the internal combustion engine each time when a crank angle sensor signal is input which is output by a crank angle sensor at each predetermined crank angle, for each forward and reverse rotation direction, after the automatic stop;
calculating a prediction time expected for the rotation speed of the internal combustion engine to reach a predetermined starter allowable rotation speed range where the starter motor can be driven, based on the rotation speed and crank angle;
updating the prediction time each time when the crank angle sensor signal is input;
determining whether or not the restart request has already been made, when the prediction time has elapsed; and
starting the drive of the starter motor when the restart request has already been made.

2. The restart control method for the internal combustion engine according to claim 1, wherein a map to which the prediction time with the rotation speed and crank angle as parameters is assigned is created in advance, and
wherein the prediction time is calculated by referring to the map.

3. The restart control method for the internal combustion engine according to claim 2, wherein the map to which the prediction time with the rotation speed and crank angle as parameters is assigned is created for each of the forward and reverse rotation directions.

4. The restart control method for the internal combustion engine according to claim 1, wherein the starter allowable rotation speed range is set with a predetermined threshold value in the forward rotation direction as an upper limit and 0 as a lower limit.

5. The restart control method for the internal combustion engine according to claim 1, wherein a value of the prediction time is set in a timer each time when the crank angle sensor signal is input, and
wherein it is determined whether or not the restart request has already been made when the value of the timer which is subtracted with a lapse of time reaches 0.

6. The restart control method for the internal combustion engine according to claim 5, wherein the value of the timer is set to an initial value when the restart request is not made when the value of the timer has reached 0.

7. The restart control method for the internal combustion engine according to claim 1, wherein the starter motor is a starter motor in which a pinion moves axially to engage with a ring gear of the internal combustion engine at the start of the drive.

8. The restart control method for the internal combustion engine according to claim 7, wherein the prediction time is set in accordance with a starter operation delay time from a command to start driving the starter motor until the pinion enters the ring gear.

9. A restart control device for an internal combustion engine for performing restarting of the internal combustion engine by using a starter motor when a restart request is made before rotation of a crankshaft completely stops after automatic stop of the internal combustion engine according to a predetermined idling stop condition, comprising:
a crank angle sensor configured to output a crank angle sensor signal at each predetermined crank angle, for each forward and reverse rotation direction;
a rotation and crank angle calculation section configured to obtain a rotation speed and crank angle of the internal combustion engine each time when the crank angle sensor signal is input, for each of the forward and reverse rotation directions, after the automatic stop;
a prediction time setting section configured to calculate a prediction time expected for the rotation speed of the internal combustion engine to reach a predetermined starter allowable rotation speed range where the starter motor can be driven, based on the rotation speed and crank angle, and update the prediction time each time when the crank angle sensor signal is input; and
a starter drive determination section configured to determine whether or not the restart request has already been made when the prediction time has elapsed, and start driving the starter motor when the restart request has already been made.
